(19) United States
(12) Patent Application Publication
(10) Pub. No.: US 2008/0192210 A1
(43) Pub. Date: Aug. 14, 2008

(54) LIGHT SOURCE DEVICE AND PROJECTOR

(75) Inventor: Tomiyoshi USHIYAMA, Minowa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/013,054

(22) Filed: Jan. 11, 2008

(30) Foreign Application Priority Data
Feb. 9, 2007 (JP) 2007-030083

(51) Int. Cl. G03B 21/20; H05B 41/36

(52) U.S. Cl. 353/85; 315/307

(57) ABSTRACT

A light source device includes: a light source unit including an arc tube that emits a light between a pair of electrodes, and a reflector that reflects the light coming from the arc tube for emission of a source light; and a drive control section that drives the light source unit by a predetermined driving power. In the device, the drive control section performs power regulation control of reducing the driving power of the light source unit at a predetermined timing by a predetermined amount.

### BACKGROUND

1. Technical Field

The present invention relates to a light source device, and a projector using the light source device.

2. Related Art

The previously known projector is of a type forming an image through modulation of a source light coming from a light source, and emitting the resulting image onto a screen or others. The previously known projector is also of a type changing a driving voltage of a light source device, i.e., lamp. As an example, Patent Document 1 (JP-A-2000-131760) describes a projector of performing control of increasing the driving voltage of a lamp at a time point when the amount of light emission of the lamp reaches a predetermined value lower than an intermediate value between the initial amount of light emission and the amount of light emission of the lamp coming close to the end of its life cycle. With this technology, images to be projected on a screen can be kept bright without shortening the life cycle of the lamp while suppressing the power consumption as much as possible.

The concern here is the configuration of the light source device for use in such a previous projector described above, i.e., the configuration of including an arc tube that is made of silica glass or others, and causes arc discharge between a pair of electrodes for illumination. If the light source device of such a configuration is used for a long time, the electrodes of the arc tube are deteriorated, thereby lengthening the arc length being the distance between the electrodes. This resultantly reduces the light-focusing efficiency in an optical system, thereby causing a problem of reducing by degrees the brightness of images. There is also a problem of degrading the brightness due to devitrification or others, which is caused by the silica glass configuring the arc tube being exposed to the high temperature. As such, when some level of brightness reduction is observed compared with the initial state, there needs to exchange the light source device, and there is thus a demand for a longer life cycle thereof. Note here that the technology of Patent Document 1 is of keeping the brightness by controlling largely the amount of light emission through increase of the driving voltage. Therefore, it is indeed capable of increasing the brightness for the time being, but instead accelerates the deterioration of the electrodes, thereby failing to increase the life cycle of the light source device.

### SUMMARY

An advantage of some aspects of the invention is to provide a light source device that is long in life cycle with less brightness reduction even if the device is used for a long time, and a projector equipped with such a light source device.

An aspect of the invention is directed to a light source device, including: a light source unit including an arc tube that emits a light between a pair of electrodes, and a reflector that reflects the light coming from the arc tube for emission of a source light; and a drive control section that drives the light source unit by a predetermined driving power. In the device, the drive control section performs power regulation control of reducing the driving power of the light source unit at a predetermined timing by a predetermined amount.

With such a light source device, the driving power of the light source unit is decreased at any predetermined timing to be lower than the driving power at the time of initial use. With such a decrease of power, the electrodes do not suffer from the heat load that much, and thus this favorably delays the progress of deterioration of the electrodes as a result of the long-time use of the light source device. This accordingly suppresses any possible brightness reduction of images that is often caused by any change of the arc length, i.e., the distance between the electrodes, due to the deterioration of the electrodes. This also suppresses any possible brightness degradation that is often caused by devitrification of the arc tube. As such, the light source device can be increased in life cycle while being remained in the initial brightness and being remained in any needed minimum necessary brightness level for a long time.

In the light source device of the aspect of the invention, the drive control section monitors an operation voltage of the light source unit, and performs the power regulation control at a timing when the amount of change of the operation voltage reaches a predetermined threshold value. Because the light source device is generally driven under constant power control, when the arc length is increased due to the deterioration of electrodes as described above, the operation voltage of the light source unit is increased. As such, any change observed to the operation voltage of the light source unit tells the degree of the deterioration of electrodes. In this aspect, the operation voltage is monitored, and at the time point when the amount of change observed thereto reaches any predetermined threshold value, the driving power of the light source unit is decreased so that the driving power can be reduced before the electrodes suffer from deterioration to some degree.

In the aspect of the invention, the drive control section may monitor an operation voltage of the light source unit, and may perform the power regulation control at a timing when an absolute value of the operation voltage reaches a predetermined threshold value. In this aspect, at a time point when the absolute value of the operation voltage reaches the predetermined threshold value, the driving power of the light source unit is reduced so that the driving power can be reduced before the electrodes suffer from deterioration to some degree.

In the aspect of the invention, the drive control section may monitor an operation voltage of the light source unit, and may perform the power regulation control in stages to reduce the driving power of the light source unit by degrees in accordance with the amount of change of the operation voltage. In this aspect, by reducing the driving power of the light source unit by degrees in accordance with the amount of change of the operation voltage, the progress of deterioration can be delayed for the electrodes.

In the aspect of the invention, the drive control section may perform the power regulation control to reduce the driving power of the light source unit by degrees in accordance with the amount of change of the operation voltage. In this aspects from a time point when the absolute value of the operation voltage reaches the predetermined threshold value, the driving power of the light source unit is reduced by degrees in accordance with the amount of change of the operation voltage, and the progress of deterioration can be delayed for the electrodes.

In the aspect of the invention, the drive control section may monitor an operation voltage of the light source unit, and may perform the power regulation control at a timing before reaching of a bending curvature point of a time-course curve when the light source unit is kept driving by the predetermined driving power. Herein, the time-course curve of the operation voltage when the light source unit is driven by the predetermined driving power has a bending curvature point where the gradient of increase shows an abrupt change. After this bending curvature point, the operation voltage is kept at a substantially fixed value. In this aspect, the driving power of the light source unit can be reduced at the time point before the operation voltage reaches the bending curvature point in this time-course curve, and the driving power can be thus reduced before the electrodes suffer from deterioration to some degree.

Another aspect of the invention is directed to a projector, including: the light source device of any of the above configurations; a light modulation section that is illuminated by an illumination light coming from the light source device, and modulates the illumination light in accordance with image information of a displaying image; and a projection system that projects an image light being a result of modulation by the light modulation section. The resulting projector can be equipped with a light source device that remains bright as in the initial state of use, and is long in life cycle while being in a brightness level needed for display for a long time.

### BRIEF DESCRIPTION OF THE DRAWINGS

The invention will be described with reference to the accompanying drawings, wherein like numbers reference like elements.

FIG. 1 is a cross sectional diagram for illustrating the configuration of a light source device of a first embodiment.

FIG. 2 is a block diagram showing the schematic configuration of a light source drive device.

FIG. 3 is a diagram for illustrating any brightness change as a result of long time use of the light source device.

FIG. 4 is a diagram showing an exemplary time-course curve of a lamp voltage.

FIG. 5 is a flowchart for illustrating the flow of a power regulation control process.

FIG. 6 is a diagram for illustrating a modified example of the power regulation control process.

FIG. 7 is a diagram for illustrating another modified example of the power regulation control process.

FIG. 8 is a diagram for illustrating still another modified example of the power regulation control process.

FIG. 9 is a conceptual view for illustrating the configuration of an optical system in a projector equipped with the light source device of the first embodiment.

### DESCRIPTION OF EXEMPLARY EMBODIMENTS

In the below, preferred embodiments of the invention are described in detail by referring to the accompanying drawings.

### First Embodiment

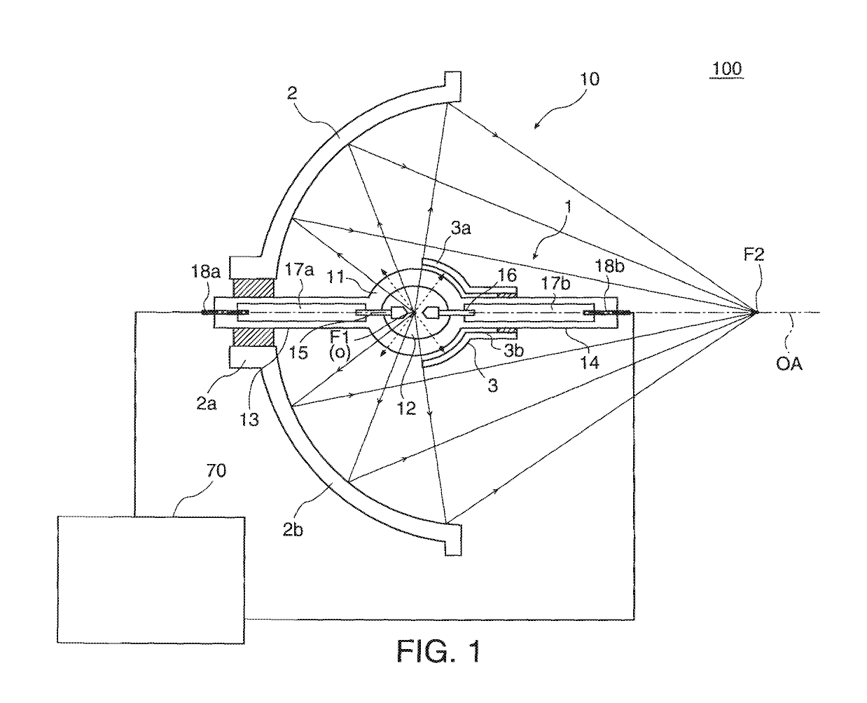

FIG. 1 is a cross sectional diagram for illustrating the configuration of a light source device of a first embodiment. A light source device 100 of the embodiment is configured to include a light source unit 10, and a light source drive device 70 corresponding to a drive control section. The light source unit 10 is configured to include an arc tube 1 of discharge emission type, a reflector 2 serving as an elliptic-shaped main reflector, and a sub-mirror 3 serving as a spherical sub reflector.

The arc tube 1 is configured by a light-transmissive silica-glass-made tube whose center portion is bulged like a sphere. The arc tube is configured to include a main portion 11 that emits lights for illumination use, and first and second sealing portions 13 and 14 that respectively extend to both end sides of the main portion 11.

The main portion 11 includes therein a discharge space 12, in which tungsten-made first and second electrodes 15 and 16 are disposed with a predetermined space from one tip end portion to the other. The space is filled with a gas being a discharge medium Including a noble gas, metal halide, and others. The sealing portions 13 and 14 respectively extending to both ends of the main portion are inserted thereinto by molybdenum-made metal foils 17a and 17b for electrical connection to the base portions of the first and second electrodes 15 and 16 provided to the body portion. The end portions of the sealing portions 13 and 14 are sealed around by a glass material or others. These metal foils 17a and 17b are connected with lead wires 18a and 18b, respectively, and when an alternating voltage is applied thereto by the light source drive device 70, arc discharge occurs between a pair of electrodes 15 and 16 so that the body portion 11 emits light with high intensity. In this configuration the reflector 2 is disposed on the side of the first electrode 15, and the sub-mirror 3 is disposed on the side of the second electrode 16, opposing the reflector 2. It means that the first electrode 15 is disposed on the side opposite to the sub-mirror 3 with the body portion 11 sandwiched therebetween.

The reflector 2 is made of silica glass, and is a piece with a neck-shaped portion 2a and a main reflection portion 2b. To the neck-shaped portion 2a, the first sealing portion 13 of the arc tube 1 is inserted and passed through, and the main reflection portion 2b looks like an elliptic curved surface extending from the neck-shaped portion 2a. The neck-shaped portion 2a is not only being inserted and passed through by the first sealing portion 13 but also serving to align the main reflection portion 2b with respect to the body portion 11.

The body portion 11 of the arc tube 1 is covered by the sub-mirror 3 for its substantially half portion on the front side from which luminous fluxes are emitted. The sub-mirror 3 is configured to include a sub reflection portion 3a and a support portion 3b. The sub reflection portion 3a puts, back to the body portion 11, the luminous fluxes emitted from the body portion 11 of the arc tube 1 toward the front. The support portion 3b is fixed around the second sealing portion 14 in the state of supporting the base portion of the sub reflection portion 3a. The support portion 3b is not only being inserted and passed through by the second sealing portion 14 but also serving to align the sub reflection portion 3a with respect to the body portion 11.

In the light source device 100 of such a configuration, the arc tube 1 is disposed along a system optical axis OA, which corresponds to the optical axis of the main reflection portion 2b of the reflector 2. The arc tube 1 is also so disposed that a light-emission center O between the first and second electrodes 15 and 16 in the body portion 11 comes at a first focal point F1 on the elliptic surface of the main reflection portion 2b. When the arc tube 1 is illuminated, the luminous fluxes coming from the body portion 11 are reflected by the main reflection portion 2b, or reflected by the main reflection portion 2b after being reflected by the sub reflection portion 3a. After reflection as such, the luminous fluxes are converged at a second focal point F2 on the elliptic surface. That is, the reflector 2 and the sub mirror 3 are each provided with a reflection surface being substantially axial symmetry with respect to the system optical axis OA. The pair of electrodes 15 and 16 is so disposed that their electrode axis being the axis center substantially matches the system optical axis OA.

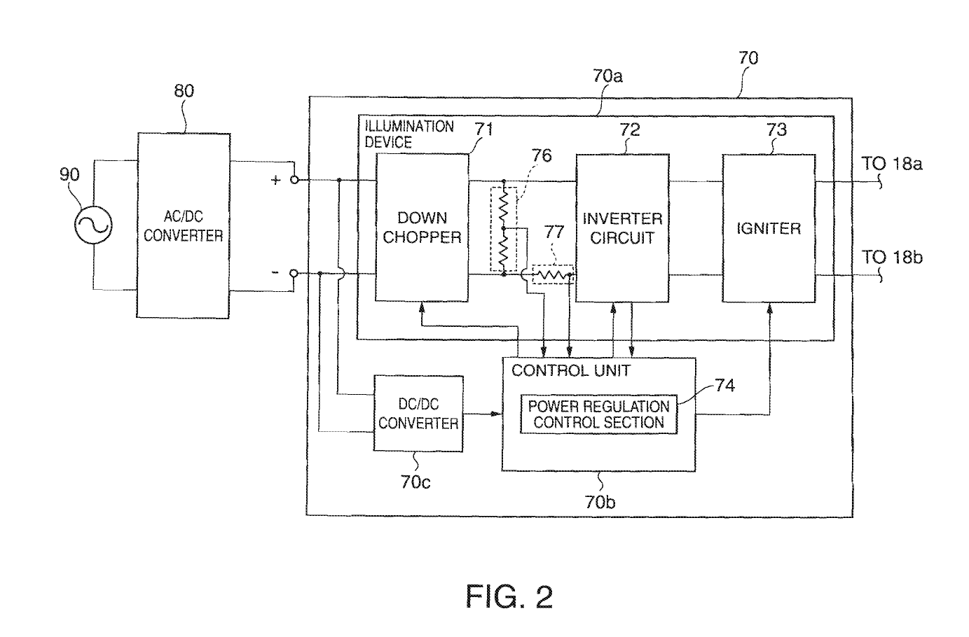

The light source drive device 70 is an electric circuit for making a supply of alternating current to the light source unit 10 to put it in any desired state of light emission. FIG. 2 is a block diagram showing the schematic configuration of the light source drive device 70. The light source drive device 70 serves to generate an alternating current for discharge between the pair of electrodes 15 and 16, and control the state of alternating current supply to the electrodes 15 and 16. The light source drive device 70 is configured to include an illumination unit 70a, a control unit 70b, and a DC (Direct Current)/DC converter 70c. In this embodiment, exemplified is a case where the light source drive device 70 uses an external power supply. That is, the light source drive device 70 is presumed as being connected to an AC (Alternating Current)/DC converter 80, and the AC/DC converter 80 is presumed as being connected to a commercial power supply 90. The AC/DC converter 80 subjects conversion, from AC to DC, to an alternating voltage coming from the commercial power supply 90.

The illumination device 70a is a portion of illuminating and driving the light source unit 10, and is configured to include a down chopper 71, an inverter circuit 72, an igniter 73, a lamp voltage detection circuit 76, and a lamp current detection circuit 77.

After receiving a supply of direct voltage coming from the AC/DC converter 80, the down chopper 71 reduces the received voltage to be of appropriate value before supplying it to the inverter circuit 72. This down chopper 71 is under the control of the control unit 70b, and adjusts the duty ratio of the periodical shutdown operation by any internal switching element, i.e., the ratio between the ON-time per unit time and the OFF-time per unit time. With such ratio adjustment, the output voltage from the down chopper 71 is adjusted.

The inverter circuit 72 serves to subject the direct voltage coming from the down chopper 71 to conversion from DC to AC, and the resulting alternating voltage of any predetermined frequency is supplied to the light source unit 10. This inverter circuit 72 is provided with a pair of inverters each being a switching element, and adjusts the timing of turning ON and OFF the switching elements in pair under the control of the control unit 70b. This enables adjustment to the output waveform from the inverter circuit 72 in terms of duty ratio and voltage ratio in positive or negative.

The igniter 73 is provided with a voltage step-up circuit that is not shown. Being under the control of the control unit 70b, when the light source unit 10 is started to be illuminated, the igniter 73 applies a high-voltage direct-voltage pulse between the electrodes 15 and 16 for a short time to cause dielectric breakdown, and generates a discharge path.

The lamp voltage detection circuit 76 is disposed between a pair of power supply lines for detection of the operation voltage of the light source unit 10. The resulting voltage detected by the lamp voltage detection circuit 76, i.e., lamp voltage, is forwarded to the control unit 70b.

The lamp current detection circuit 77 is provided to one of the power supply lines for detection of the operation current of the light source unit 10. The resulting current detected by the lamp current detection circuit 77 is forwarded to the control unit 70b.

The control unit 70b is configured by a microprocessor, for example, and drives and controls the illumination unit 70a. The control unit 70b is driven by the drive voltage of any appropriate value generated by the DC/DC converter 70c.

This control unit 70b is provided with a power control section 74, and operates the igniter 73 at the same time as illumination to start discharge with respect to the arc tube 1 of the light source unit 10. The control unit 70b also controls the down chopper 71 to drive the light source unit 10 with any predetermined level of power. For example, the control unit 70b adjusts the drive current before supplying it to the lead wires 18a and 18b of the light source unit 10 through control of the down chopper 71, and makes the down chopper 71 to supply the power of a constant level between the electrodes 15 and 16 of the light source unit 10.

More in detail, the power control section 74 goes through a power regulation control process so that the light source unit 10 is driven by any predetermined level of power corresponding to the currently-activated drive mode. The light source device 100 is set in an initial drive mode when it is started to be used, and the mode is switched to a long-life-cycle drive mode at any predetermined timing for switching. The power control section 74 determines what drive mode is currently activated at the time of illumination, and when the initial mode is determined as being currently activated, drives the light source unit 10 with the initial level of power as has been previously done, i.e., standard control. On the other hand, when the long-life-cycle drive mode is determined as being currently activated, the power for use to drive the light source unit 10 is changed to the level being lower by a predetermined amount compared with the initial level, i.e., power regulation control process. The amount of power to be reduced is appropriately set to be within a range of being able to keep any needed level of brightness in an optical device using the light source device 100 as a light source, e.g., projector. As described above, when being used for a long time, the light source device 100 shows reduction of brightness due to deterioration of the electrodes 15 and 16. However, with such a power regulation control process, the drive power can be reduced before the electrodes are deteriorated to some degree so that the light source device 100 can be of any needed brightness for a long time while the initial level of brightness is kept as previously done.

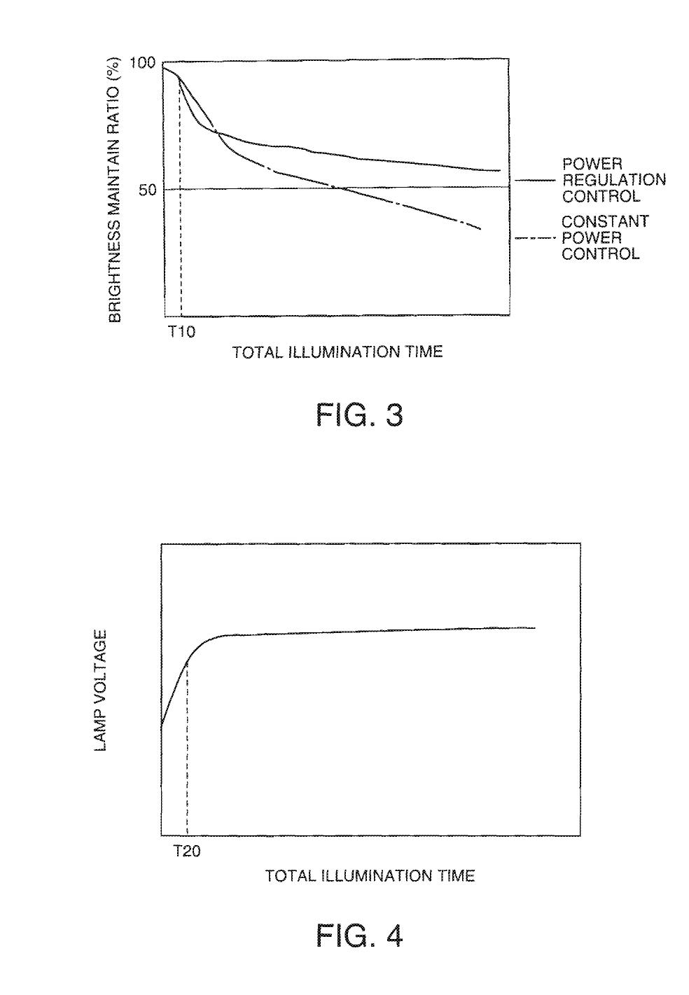

FIG. 3 is a diagram for illustrating a change of brightness as a result of the long time use of the light source device 100. In the drawing, the lateral axis denotes the illumination time in total and the vertical axis denotes the brightness maintain ratio, and a solid line indicates the brightness maintain ratio when the power regulation control process is performed as above. The curve of the brightness maintain ratio is an example when the power regulation control process is performed for mode switching from the initial drive mode to the long-life-cycle drive mode with a switching timing of T10. In the drawing, long and short dashed lines denote the brightness maintain ratio if with standard control, i.e., constant power control, to keep driving the light source unit 10 with the initial level of power as has been previously done. As shown in FIG. 3, when the light source unit 10 is illuminated as a result of the power regulation control process, the driving power of the initial level is reduced at the timing of T10 by a predetermined amount, and thus the brightness temporarily shows a reduction compared with the case of illuminating the light source unit 10 through previous constant power control. However, advantageously, the electrodes 15 and 16 are protected from deterioration to some degree by reducing the heat load thereto so that the brightness is prevented from being reduced that much. As such, the brightness after the long-time use is instead increased so that the brightness can be kept for a much longer time compared with the previous technology.

In practical use, the timing of switching the initial drive mode to the long-life-cycle drive mode for the aim of reduction of a driving power is set based on any over-time change observed to the lamp voltage after the previous constant power control is applied, i.e., after the light source unit 10 is kept running with the initial level of power. FIG. 4 is a diagram showing an exemplary time-course curve of the lamp voltage. As shown in FIG. 4, when the light source unit 10 is kept running with the initial level of power, the lamp voltage shows an increase with any change of the arc length observed as a result of deterioration of electrodes. The lamp voltage is kept at a substantially constant value after a bending curvature point where the gradient of increase shows an abrupt change. In this embodiment, a predetermined timing before the bending curvature point in the time-course curve, e.g., timing T20, is set as a drive mode switching timing. In this case, T20 corresponds to T0 a of FIG. 3. While the light source unit 10 is running in the initial drive mode, the power control section 74 monitors the lamp voltage to be detected by the lamp voltage detection circuit 76, and at the switching timing set as above, i.e., at the timing when the value of the lamp voltage reaches the threshold value, the initial drive mode is switched to the long-life-cycle drive mode to reduce the driving power.

Alternatively, the drive mode switching timing may be set in consideration of the characteristics of the light source device 100. That is, if with such characteristics as showing sensitive brightness change in response to the arc length change, the switching timing may be so adjusted as to enable switching of drive mode in an earlier stage, i.e., when the lamp voltage is low. On the other hand, if with such characteristics as not showing brightness change unless the arc length is greatly changed, the switching timing may be so adjusted as to enable switching of drive mode after the lamp voltage is increased to some degree.

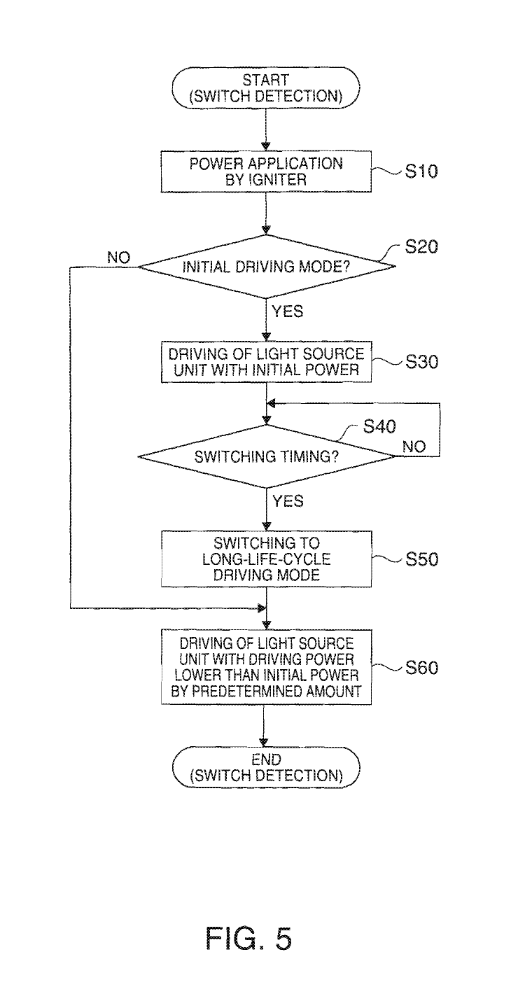

FIG. 5 is a flowchart for illustrating the flow of the power control process. This process is started when the operation of a light-on switch is detected, and is ended when the operation of a light-off switch is detected.

That is, first of all, the power control section 74 operates the igniter 73 to start discharge with respect to the arc tube 1 of the light source unit 10 (step S10). The power control section 74 then determines the currently-activated drive mode. If with the initial drive mode (step S20: YES), the power control section 74 operates the down chopper 71 as appropriate, and makes the light source unit 10 with the initial level of power (step S30). The power control section 74 then monitors the lamp voltage to be detected by the lamp voltage detection circuit 76, and when the current lamp voltage reaches a value set for the switching timing as described by referring to FIG. 4 (step S40: YES), performs mode switching from the initial drive mode to the long-life-cycle drive mode (step S50). The power control section 74 then operates the down chopper 71 as appropriate to reduce the initial level of driving power by a predetermined amount to make the light source unit 10 emit lights (step S60). When the operation of a light-on switch is detected, this process is also started, and when the determination result in step S20 tells that the long-life-cycle drive mode is currently activated, the process of step S60 is executed to make the light source unit 10 emit lights with the power being the result of reducing the initial level of power by a predetermined amount.

As described in the foregoing, when the light source device 100 is started to be used, the light source unit 10 is driven with the initial level of power as has beer previously done. Thereafter, at a time point when the lamp voltage reaches a predetermined threshold value, the driving power is reduced by a predetermined amount. This favorably delays the progress of deterioration of electrodes so that the light source device 100 can be of any needed brightness for a long time while the initial level of brightness is kept. What is better, any possible brightness degradation due to devitrirication or others of the arc tube as a result of deterioration of electrodes can be suppressed so that the light source device 100 can be increased in life cycle.

Note that, in the light source device described above, the lamp for use in the light source unit 10 may vary in type, e.g., high-pressure mercury lamp and halide lamp.

In the first embodiment described above, the power regulation control process is of reducing the driving power when the lamp voltage reaches a predetermined threshold value. Alternatively, the following modified examples are possible.

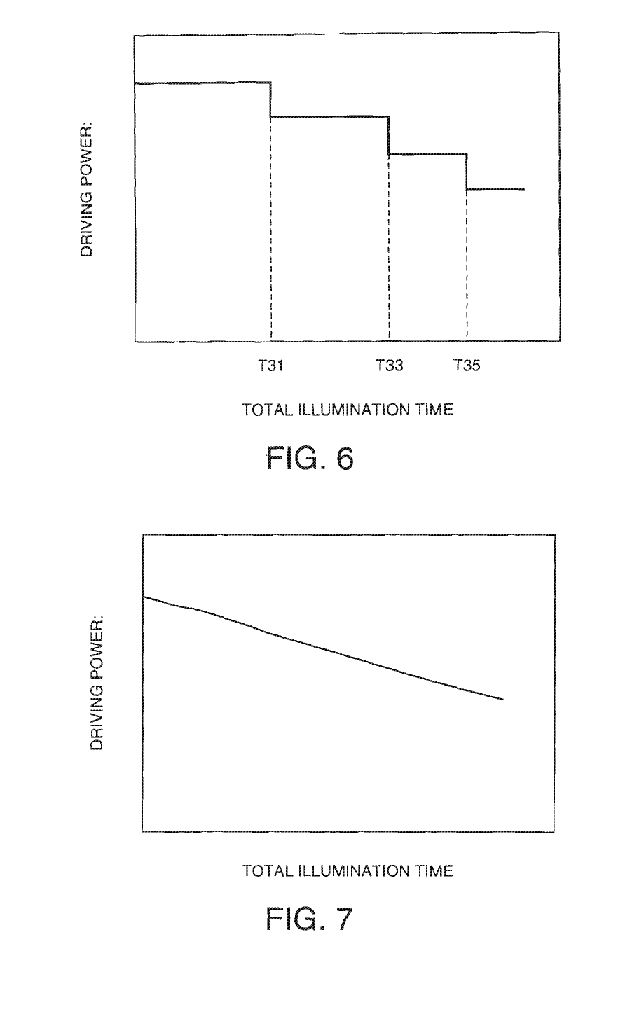

FIG. 6 is a diagram for illustrating a modified example of the power regulation control process. As shown in FIN 6 in this modified example, the power regulation control process is of monitoring the lamp voltage of the light source unit 10, and reducing the driving power of the light source unit 10 in stages in such a manner that the driving power is reduced by degrees in accordance with the amount of change observed to the lamp voltage. More in detail, for example, every time the amount of change observed to the lamp voltage of the light source unit 10 reaches a preset predetermined value, the power regulation control process is executed to reduce the driving power of the light source unit 10 by a predetermined amount. This enables to delay the progress of deterioration of electrodes, and leads to the effects similar to those of the first embodiment.

FIG. 7 is a diagram for illustrating another modified example of the power regulation control process. As shown in FIG. 7, in this modified example, the power regulation control process is of monitoring the lamp voltage of the light source unit 10, and successively reducing the driving power of the light source unit 10 in accordance with the amount of change observed to the lamp voltage. That is, the power regulation control process is executed right from the initial operation. This enables to delay the progress of deterioration of electrodes, and leads to the effects similar to those of the first embodiment.

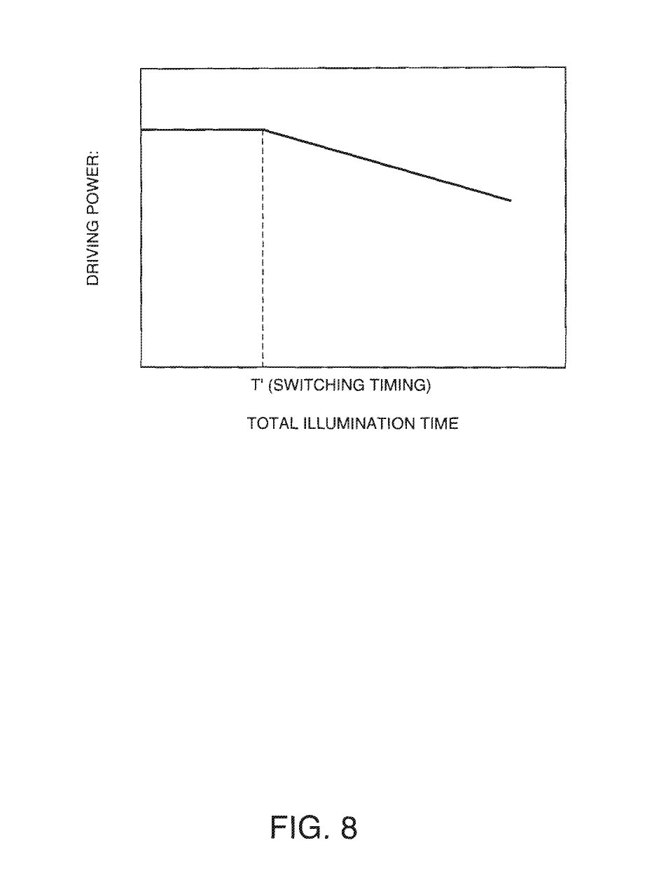

Alternatively, the power regulation control process may be executed as below. That is, based on the lamp voltage of the light source unit 10 when the light source device 103 is started to be used, the power regulation control process may be executed to reduce the driving power by degrees when the amount of change observed to the lamp voltage reaches a predetermined threshold value (refer to FIG. 8).

In the first embodiment above, described is the case of reducing the initial driving power at a predetermined timing by a predetermined amount on the precondition that the light source unit 10 is driven by a constant power. Alternatively, the light source unit 10 may be driven by a constant current, and the initial driving current may be reduced at a predetermined timing by a predetermined amount.

### Second Embodiment

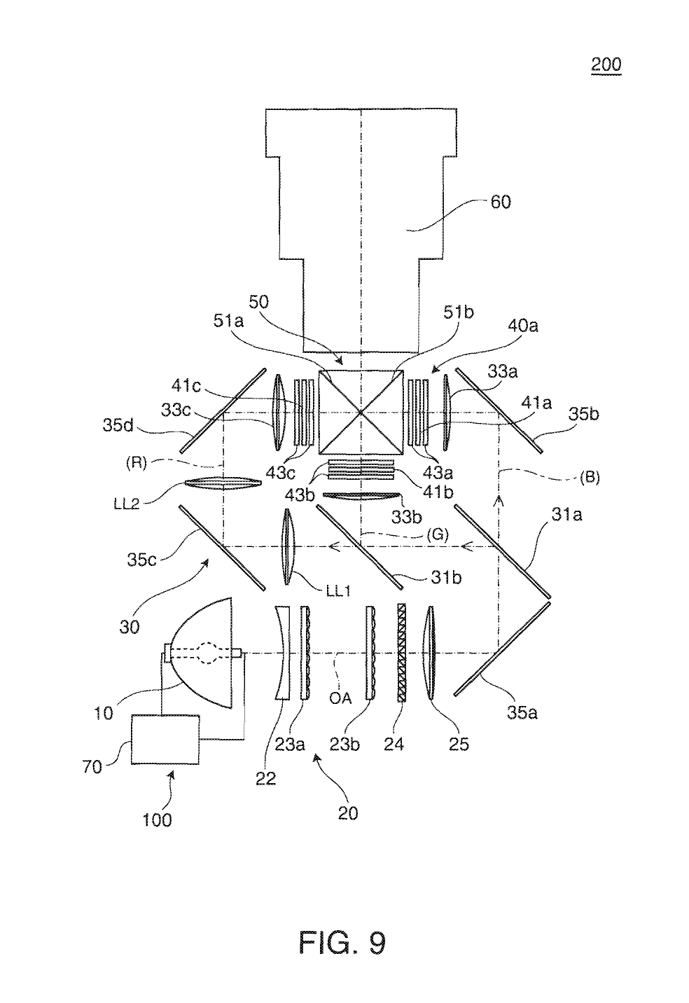

FIG. 9 is a conceptual view for illustrating the configuration of an optical system in a projector equipped with the light source device of the first embodiment. This projector 200 is configured to include the light source device 100 of FIG. 1, an illumination system 20, a color separation system 30, a light modulation section 40, a cross dichroic prism 50, and a projection lens 60, all of which are disposed in order along the optical axis OA. The illumination system 20 serves to make source lights uniform before emission, and the color separation system 30 divides the light sources coming from the illumination system 20 into three colors of red, green, and blue. The light modulation section 40 is illuminated by the source lights of various colors coming from the color separation system 30, arid the cross dichroic prism 50 combines image lights of various colors coming from the light modulation section 40. The projection lens 60 is a projection system for use to project the image lights through with the cross dichroic prism 50 onto a screen that is not shown.

The illumination system 20 is configured to include a concave lens 22, a pair of first arid second lens arrays 23a and 23b, a polarization conversion member 24, and a superimposing lens 25. The concave lens 22 collimates the source lights coming from the light source device 100. The pair of first and second lens arrays 23a and 23b are each a plurality of element lenses in matrix. With these element lenses, after going through the concave lens 22, the source lights coming from the light; source device 100 are divided for individual light focusing and divergence. The polarization conversion member 24 subjects the source lights coming from the second lens array 23b to conversion, and the result, e.g., only S polarized components vertical to the paper surface of FIN 9, is supplied to the optical system in the next stage. The superimposing lens 25 serves to entirely converge, as appropriate, the source lights through with the polarization conversion member 24. The source lights through with the superimposing lens 25 as such are then directed to the color separation system 30, and illuminates, through uniform overlay, liquid crystal panels 41a, 41b, and 41c provided to the light modulation section 40.

The color separation system 30 is configured to include first and second dichroic mirrors 31a and 31b, three field lenses 33a, 33b, and 33c each being a correction system, and reflection mirrors 35a, 35b, 35c, and 35d. In this configuration, out of the three colors of red, green, and blue, the first dichroic mirror 31a reflects lights of red and green but passes through the lights of blue, for example. For the incoming lights of red and green, the second dichroic mirror 31b reflects the lights of green but passes through the lights of red, for example. In such a color separation system 30, the source lights of substantially white color coming from the light source device 100 are directed to the first dichroic mirror 31a with their optical path bent by the reflection mirror 35a. After passing through the first dichroic mirror 31a, the lights of blue are directed to the reflection mirror 35b, and then to the field lens 33a while remaining as being S-polarized lights, for example. The light of green reflected by the first dichroic mirror 31a and then by the second dichroic mirror 31b are directed to the field lens 33b while remaining as being S-polarized lights, for example. After passing through the second dichroic mirror 31b, while remaining as being S-polarized lights, the lights of red are directed to lenses LL1 and LL2 and the reflection mirrors 35c and 35d, and then to the field lens 33c for adjustment of the light-entering angle. These lenses, i.e., the lenses LL1 and LL2, and the field lens 33c, are configuring the relay system. This relay system has a function of transmitting images derived by the first lens LL1 substantially as they are to the field lens 33c via the second lens LL2.

The light modulation section 40 is configured to include the three liquid crystal panels 41a, 41b, and 41c, three polarization filters 43a, 43b, and 43c. The polarization filters 43a, 43b, and 43c are each in pair, and are each disposed to sandwich each corresponding liquid crystal panel 41a, 41b, or 41c. In this example, the liquid crystal panel 41a for the lights of blue and the pair of polarization filters 43a and 43a configure a blue-light liquid crystal light valve for two-dimensionally modulating the intensity of source lights of blue based on image information. Similarly, the liquid crystal panel 41b for the lights of green and the pair of polarization filters 43b and 43b configure a green-light liquid crystal light valve, and the liquid crystal panel 41c for the lights of red and the pair of polarization filters 43c and 43c configure a red-light liquid crystal light valve.

To the liquid crystal panel 41a for lights of blue, blue lights being the branching result of reflection by the first dichroic mirror 31a of the color separation system 30 are directed via the field lens 33a. To the liquid crystal panel 41b for light of green, green lights being the branching result of reflection by the second dichroic mirror 31b of the color separation system 30 are directed via the field lens 33b. To the liquid crystal panel 41c for lights of red, red lights being the branching result of reflection by the second dichroic mirror 31b are directed via the field lens 33c. The lights of three colors directed to the liquid crystal panels 41a, 41b, and 41c as such are modulated in accordance with a drive signal or an image signal provided to the liquid crystal panels 41a, 41b, and 41c as an electric signal. At the time of modulation, with the polarization filters 43a, 43b, and 43c, the polarization direction of the source lights entering the liquid crystal panels 41a, 41b, and 41c is correctly adjusted, and from the modulated lights to be emitted from the liquid crystal panels 41a, 41b, and 41c, component lights of any predetermined polarization direction are extracted as image lights.

The cross dichroic prism 50 is a light combining member, is of square when viewed from above with four right-angle prisms attached together. The interface of the right-angle prisms is formed with a substantially-X-shaped pair of first and second dielectric multilayer films 51a and 51b. The first dielectric multilayer film 51a reflects the lights of blue, and the remaining second dielectric multilayer film 51b reflects the lights of red. In such a cross dichroic prism 50, the lights of blue from the liquid crystal panel 41a are reflected by the first dielectric multilayer film 51a for emission to the right side of the heading direction. The lights of green from the liquid crystal panel 41b are directed straight for emission via the first and second dielectric multilayer films 51a and 51b, and the lights of red from the liquid crystal panel 41c are reflected by the second dielectric multilayer film 51b for emission to the left side of the heading direction.

The projection lens 60 projects, onto a screen, the image lights of various colors being the results of color combination in the cross dichroic prism 50 with a predetermined scaling factor. That is, projected on the screen are moving or still color images of any predetermined scaling factor corresponding to a drive signal or an image signal input to the liquid crystal panels 41a, 41b, and 41c.

The projector 2000f such a configuration is using the light source device 100 described in the first embodiment. Accordingly, the projector can be secured with the initial brightness with the long-life light source device that can keep any needed brightness for a long time, thereby reducing the exchange frequency of the light source device.

Note that, in the projector 200 described above, the illumination system 20 is configured by the concave lens 22, a pair of first and second lens arrays 23a and 23b, the polarization conversion member 24, and the superimposing lens 25. This is surely not restrictive, and the components, i.e. the first and second lens arrays 23a and 23b, the polarization conversion member 24, and others, may be omitted. Alternatively, the components, the concave lens 2 and the first and second lens arrays 23a and 23b, may be replaced by a rod integrator.

With the light source device 100 described above, the main reflection portion 2b of the reflector 2 looks like an elliptic curved surface, but it may look like a parabolic curved surface. When the optical system of a projector is equipped with a light source device including a reflector including a main reflection portion looking like a parabolic curved surface as such, the concave lens 22 may be omitted.

With the projector 200 described above, the color separation system 30 is used to subject source lights to color separation, and images of various colors are combined in the cross dichroic prism 50 after color modulation in the light modulation, section 40. This is also applicable to projectors performing color modulation using a single liquid crystal panel, two liquid crystal panels, or four or more liquid crystal panels.

For modulation and combination of various colors of lights, a combination of color wheel and a digital micromirror device may be used as alternatives to the color separation system 30 and the light modulation section 40. The color wheel is the one to be illuminated by the light source device 100 and the illumination system 20, and the digital micromirror device is the one to be illuminated by lights through with the color wheel.

In the second embodiment, described is the exemplary case in which the invention is applied to a projector of a light-transmissive type. The invention is surely applicable to a reflective projector. Herein, the “light-transmissive type” denotes a type that a light modulation section including a liquid crystal panel or others transmits lights, and the “reflective type” denotes a type that the light modulation section reflects lights.

Moreover, a projector includes a front-projection-type projector that performs projection from the direction of observing a screen, and a rear-projection-type projector that performs projection from the side opposite to the direction of observing the screen. The invention is surely applicable to both types of the projector.

The entire disclosure of Japanese Patent Application No. 2007-030083, filed Feb. 9, 2006 is expressly incorporated by reference herein.

What is claimed is:

1. A light source device, comprising:
a light source unit including an arc tube that emits a light between a pair of electrodes, and a reflector that reflects the light coming from the arc tube for emission of a source light; and
a drive control section that drives the light source unit by a predetermined driving power, wherein
the drive control section performs power regulation control of reducing the driving power of the light source unit at a predetermined timing by a predetermined amount.

2. The light source device according to claim 1, wherein
the drive control section monitors an operation voltage of the light source unit, and performs the power regulation control at a timing when an amount of change of the operation voltage reaches a predetermined threshold value.

3. The light source device according to claim 2, wherein
the drive control section performs the power regulation control to reduce the driving power of the light source unit by degrees in accordance with the amount of change of the operation voltage.

4. The light source device according to claim 1, wherein
the drive control section monitors an operation voltage of the light source unit, and performs the power regulation control at a timing when an absolute value of the operation voltage reaches a predetermined threshold value.

5. The light source device according to claim 4, wherein
the drive control section performs the power regulation control to reduce the driving power of the light source unit by degrees in accordance with the amount of change of the operation voltage.

6. The light source device according to claim 1, wherein
the drive control section monitors an operation voltage of the light source unit, and performs the power regulation control in stages to reduce the driving power of the light source unit by degrees in accordance with an amount of change of the operation voltage.

7. The light source device according to claim 1, wherein
the drive control section monitors an operation voltage of the light source unit, and performs the power regulation control at a timing before reaching of a bending curvature point of a time-course curve when the light source unit is kept driving by the predetermined driving power.

8. A projector, comprising:
the light source device of claim 1;
a light modulation section that is illuminated by an illumination light coming from the light source device, and modulates the illumination light in accordance with image information of a displaying image; and
a projection system that projects an image light being a result of modulation by the light modulation section.

9. The projector according to claim 8, wherein
the drive control section monitors an operation voltage of the light source unit, and performs the power regulation control at a timing when an amount of change of the operation voltage reaches a predetermined threshold value.

10. The projector according to claim 9, wherein
the drive control section performs the power regulation control to reduce the driving power of the light source unit by degrees n accordance with the amount of change of the operation voltage.

11. The projector according to claim 8, wherein
the drive control section monitors an operation voltage of the light source unit, and performs the power regulation control at a timing when an absolute value of the operation voltage reaches a predetermined threshold value.

12. The light source device according to claim 11, wherein
the drive control section performs the power regulation control to reduce the driving power of the light source unit by degrees accordance with the amount of change of the operation voltage.

13. The projector according to claim 8, wherein
the drive control section monitors an operation voltage of the light source unit, and performs the power regulation control in stages to reduce the driving power of the light source unit by degrees in accordance with an amount of change of the operation voltage.

14. The projector according to claim 8, wherein
the drive control section monitors an operation voltage of the light source unit, and performs the power regulation control at a timing before reaching of a bending curvature point of a time-course curve when the light source unit is kept driving by the predetermined driving power.
